(19) United States
(12) Patent Application Publication
(10) Pub. No.: US 2024/0322927 A1
(43) Pub. Date: Sep. 26, 2024

(54) APPARATUS FOR PRECISE TIMESTAMPING OF START OF ETHERNET FRAME

(71) Applicant: Texas Instruments Incorporated, Dallas, TX (US)

(72) Inventors: Kalpesh Laxmanbhai Rajai, Bangalore (IN); Sankar Prasad Debnath, Bangalore (IN); Geet Govind Modi, Bangalore (IN)

(21) Appl. No.: 18/346,019

(22) Filed: Jun. 30, 2023

(30) Foreign Application Priority Data
Mar. 24, 2023 (IN) 202341020859

(51) Int. Cl. H04J 3/06

(52) U.S. Cl. CPC H04J 3/0664; H04J 3/0682

(57) ABSTRACT

Systems, apparatus, articles of manufacture, and methods are described for precise timestamping of an Ethernet frame. In some implementations, a device may include network interface circuitry; logic circuitry configured to execute instructions to cause the logic circuitry to: determine a first delay introduced by a physical coding sublayer circuitry at a first time; adjust a first timestamp associated with a first transmission based on the first delay, the first timestamp transmitted with the first transmission; determine a second delay introduced by the physical coding sublayer circuitry at a second time, the second delay different than the first delay; and adjust a second timestamp associated with a second transmission based on the second delay, the second timestamp transmitted with the second transmission.

### RELATED APPLICATION

This patent claims priority to Indian Provisional Patent Application No. 202341020859, filed on Mar. 24, 2023. Indian Provisional Patent Application No. 202341020859 is hereby incorporated herein by reference in its entirety.

### TECHNICAL FIELD

This description relates generally to network communications and, more particularly, to apparatus for precise timestamping of the start of an Ethernet frame.

### BACKGROUND

Networked devices often rely upon precise time synchronization among multiple devices to facilitate synchronized timing of actions. For example, some systems utilize a master clock that synchronizes a clock among multiple slave devices. Some such examples utilize messaging to communicate a master clock time against which the slave devices can synchronize their clocks.

### BRIEF DESCRIPTION OF THE DRAWINGS

FIG. 1 is a block diagram of an example environment in which a slave device synchronizes a time with a master time server.

FIG. 2 illustrates an example messaging for time synchronizing including an adjustment of timestamps to account for variable delays.

FIGS. 3A, 3B are a block diagram of an example transmit component of the master time server and an example receive component of the slave device of FIG. 1.

FIG. 4 is a block diagram of an example implementation of an Ethernet physical layer (PHY) including an egress tracking circuit and an ingress tracking circuit.

FIGS. 5, 7, 8, 12, and 14 are flowcharts representative of example machine readable instructions and/or example operations that may be executed, instantiated, and/or performed by programmable circuitry to implement the egress time correction circuitry and/or the ingress time correction circuitry of FIGS. 1 and/or 3.

FIGS. 6A and 6B are block diagrams of example implementations of physical coding sublayers (PCS).

FIGS. 9, 10, 11, and 13 illustrate various variable delays introduced by a physical coding sublayer during time synchronization.

FIG. 15 is a block diagram of an example processing platform including programmable circuitry structured to execute, instantiate, and/or perform the machine readable instructions and/or perform the operations of FIGS. 5, 7, 8, 12, and 14 to implement the egress time correction circuitry 108, 124, 312, 404 of FIGS. 1, 3, and/or 4 and/or the ingress time correction circuitry 112, 120, 330, 412 of FIGS. 1, 3, and/or 4.

FIG. 16 is a block diagram of an example implementation of the programmable circuitry of FIG. 15.

FIG. 17 is a block diagram of another example implementation of the programmable circuitry of FIG. 15.

FIG. 18 is a block diagram of an example software/firmware/instructions distribution platform (e.g., one or more servers) to distribute software, instructions, and/or firmware (e.g., corresponding to the machine readable instructions of FIGS. 5, 7, 8, 12, and 14) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts.

### DETAILED DESCRIPTION

In systems that utilize time synchronization, a master time server sends messages with timestamps that allow a slave device to determine an adjustment to a clock of the slave device while excluding communication delays. Such approaches can be successful when communication delays are consistent. However, when delays in the communication process are variable, such approaches may not determine an accurate synchronized time. For example, after a message is embedded with a timestamp, the time for encoding the message and/or the time for decoding the message may take a variable length of time. In such examples, the slave device may not determine an accurate adjustment to a clock due to the variability.

Methods and apparatus described herein facilitate precise time synchronization by adjusting time values (e.g., timestamps, clock times, time serial numbers, etc.) associated with messages, such as time synchronization messages, to account for the variable delays. For example, a delay associated with an encoding time during message transmission may be predicted and the timestamp inserted into the message may be adjusted to compensate for the predicted delay. In other examples, a delay associated with decoding a message may be predicted and the timestamp may be adjusted accordingly. By adjusting the timestamp to account for the variable delays of encoding and/or decoding, the clock of a slave device may be more accurately adjusted to synchronize more closely with a master time server.

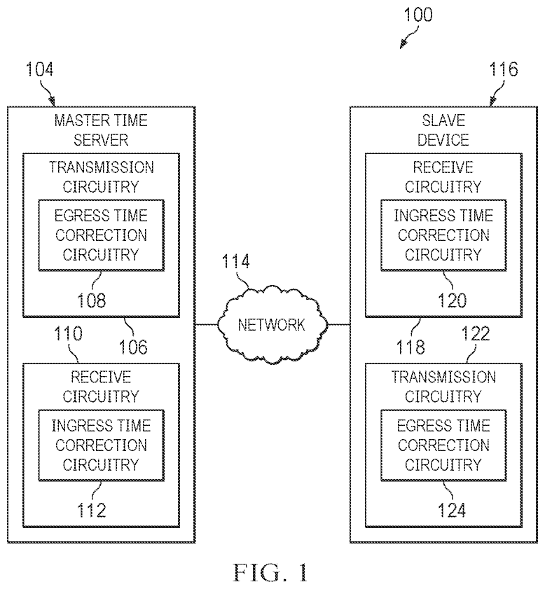

FIG. 1 is a block diagram of an example environment 100 that includes a master time server 104 and a slave device 116 that may communicate over a network 114. Master time server 104 includes transmission circuitry 106 that includes an egress time correction circuitry 108 and includes receive circuitry 110 that includes an ingress time correction circuitry 112. Network 114 communicatively couples the master time server 104 to the slave device 116. The slave device 116 includes receive circuitry 118 that includes ingress time correction circuitry 120 and transmission circuitry 122 that includes egress time correction circuitry 124. The master time server 104 is connected to the network 114 via the transmission circuitry and the receive circuitry 110. The slave device 116 is coupled to the network 114 (and therefore to the master time server 104 via the network 114) via the receive circuitry 118 and the transmission circuitry 122.

The master time server 104 provides messaging to facilitate time synchronization among one more slave devices such as the slave device 116. The master time server 104 may be any type of computing device such as a server, a client, a controller in a vehicle, an Internet of Things device, etc. To facilitate time synchronization, the master time server 104 includes the transmission circuitry 106 for transmitting time synchronization messages (e.g., Sync and Delay Response messages) and the receive circuitry 110 for receiving time synchronization messages (e.g., Delay Request messages). The master time server 104 may support time synchronization based on the messaging set forth in any version of Institute of Electrical and Electronics Engineers (IEEE) 1588—Standard for a Precision Clock Synchronization Protocol for Networked Measurement and Control Systems.

In an example, the slave device 116 of FIG. 1 is a controller in an automotive control system. Alternatively, the slave device 116 may be any other type of device for which time synchronization of one or more clocks with the master time server 104 is desired.

In an example, the transmission circuitry 106 and the transmission circuitry 122 and the receive circuitry 110 and the receive circuitry 120 are Ethernet PHYs that include respective physical coding sublayers that perform encoding on messages for transmission and decoding on received messages, respectively. The physical coding sublayer and/or any other component that performs encoding and/or decoding may introduce errors that vary over time and/or from message to message. For example, a first delay is associated with transmission of a first message and a second delay, that is different than the first delay, is associated with transmission of a second message. Accordingly, when time synchronization is performed without accounting for the variability of the encoding and decoding delays, the adjustment of a clock of the slave device 116 may lead to a clocking timing that is out of sync with the master time server 104. Accordingly, the transmission circuitry 106 and the transmission circuitry 122 include the egress time correction (ETC) circuitry 108 and the egress time correction (ETC) circuitry 124, respectively, and the receive circuitry 112 and the receive circuitry 120 include the ingress time correction (ITC) circuitry 112 and the ingress time correction circuitry 120, respectively.

The time correction circuitries 108, 112, 120, and 124 monitor and/or detect a state of the physical coding sublayer (or other encoder/decoder) to determine a delay that will result from encoding or has resulted from decoding of a message. For example, the time correction circuitries 108, 112, 120, and 124 include latency tracking circuitry to track the state of the physical coding sublayer and latency correction circuitry that adjusts a generated timestamp to account for the latency resulting from the encoding or decoding. The state of the physical coding sublayer may include the timing and/or phases of one or more clock signals of the physical coding sublayer, a state of a communication path and/or multiplexer of the physical coding sublayer, a communication state of blocks within a communication frame, etc.

The network 114 communicatively couples the master time server 104 to the slave device 116 via Ethernet protocols, in one example. The network 114 may also communicatively couple any number of other devices. Furthermore, the network 114 may utilize any other type of networking protocol that is supported by the master time server 104 and the slave device 116. The network 114 may be implemented by network circuitry for coupling multiple devices such as a switch, a hub, a router, a gateway, etc. Alternatively, the network 114 may be a cable (e.g., an Ethernet cable) that couples the master time server 104 with the slave device 116.

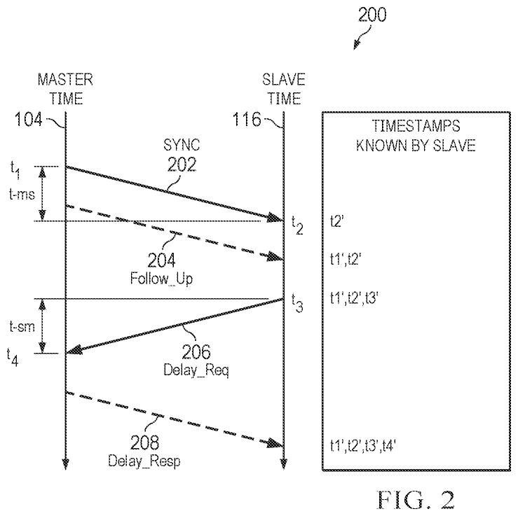

FIG. 2 illustrates an example message diagram 200 that shows the operation of the devices in FIG. 1. According to FIG. 2, the master time server 104 transmits, via the transmission circuitry 106, a sync message 202 to the slave device 116, which receives the sync message 202 via the receive circuitry 118. The slave device 116 determines the timestamp t₂ as the time after the message is received and decoded. The ingress time correction circuitry 120 determines an adjusted time t₂′ that is the timestamp t₂ adjusted to compensate for the variable delay introduced by decoding the sync message 202.

The egress time correction circuitry 108 adjusts the timestamp t₁ that is the timestamp assigned to the sync message 202 to compensate for the variable delay in encoding that occurs after the timestamp t₁ is determined. The adjusted timestamp t₁′ is transmitted to the slave device 116 via a follow-up message 204. The timestamp t₁′ may also or alternatively be included in the sync message 202.

The slave device 116 then transmits a delay request message 206 to the master time server 104. The egress time correction circuitry 124 determines an adjusted timestamp t₃′ based on the timestamp t3 determined prior to the transmission circuitry 124 encoding the delay request message 206 to compensate for the variable delay due to the encoding. The master time server 104 determines an adjusted timestamp t₄′ based on the timestamp t₄ determined after the receive circuitry 112 has decoded the delay request message 206 to compensate for the variable delay introduced by the decoding. The master time server 104 transmits a relay response message 208 to the slave device 116 to transmit the adjusted timestamp t4′ to the slave device 116.

The ingress time correction circuitry 120 then utilizes the determined adjusted timestamps to determine a clock adjustment for a clock of the slave device 116. According to the illustrated example, the clock adjustment is determined as: ½ (t₂′−t₁′−t₄′−t₃′), where, assuming that the transmission latency between the master time server and the slave time server is fixed, the transmission delay is eliminated by the equation such that the resulting value is the time difference between the clock of the master time server 104 and the clock of the slave device 116. Accordingly, the ingress time correction circuitry 120 adjusts the time of the clock to eliminate the difference and synchronize the clocks.

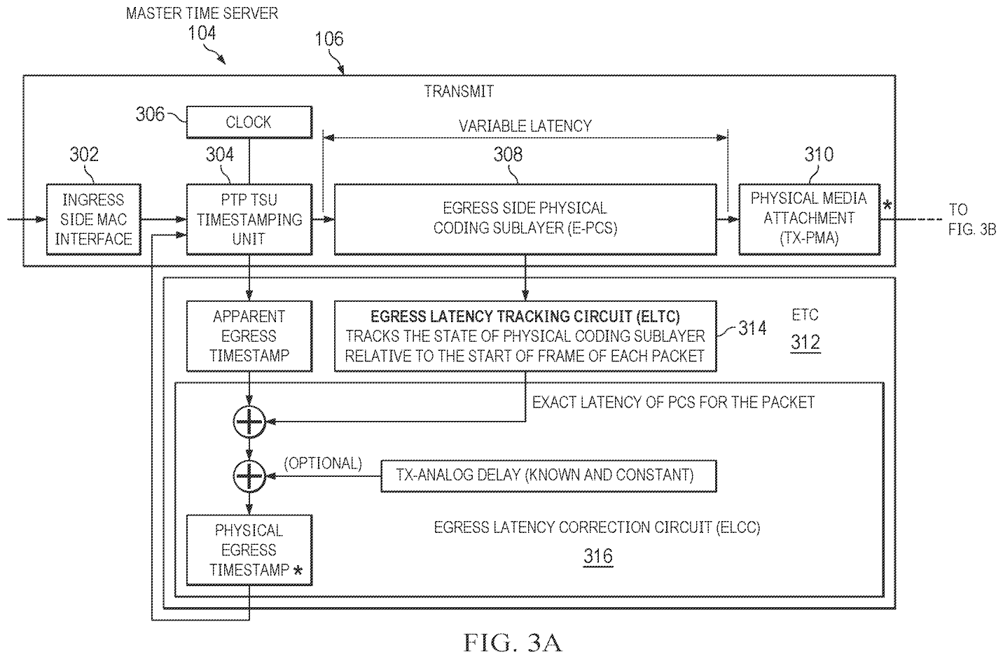

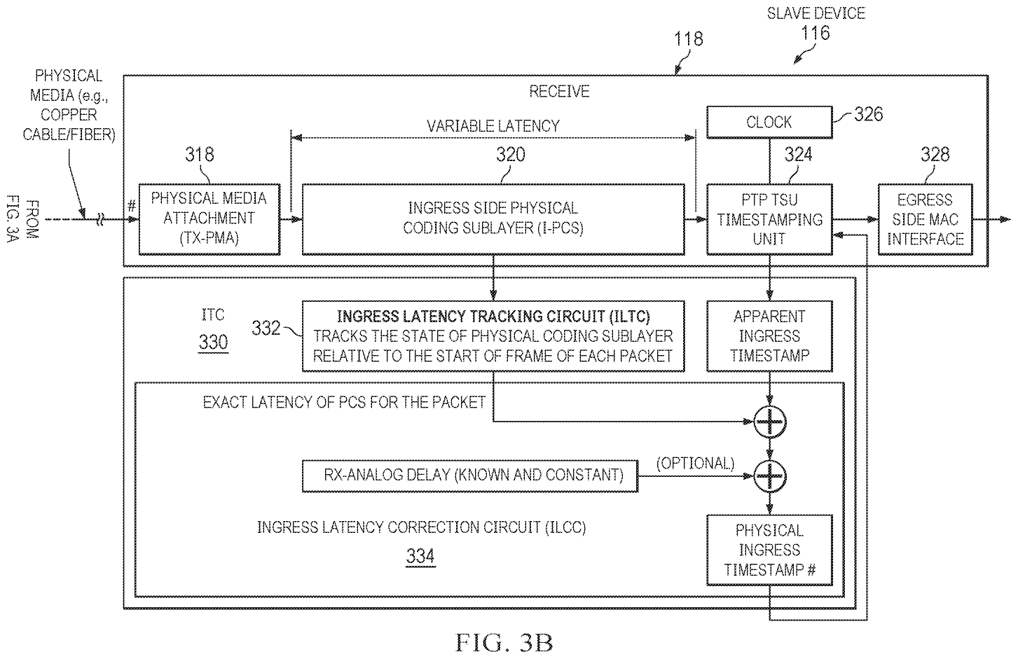

FIGS. 3A, 3B are a block diagram of an example implementation of the transmission circuitry 106 of the master time server 104 of FIG. 1 and the receive circuitry 118 of the slave device 116 of FIG. 1. While the transmission circuitry 106 is shown for illustration, the illustrated blocks may implement the transmission circuitry 122 of the slave device 116. Similarly, while the receive circuitry 118 is illustrated in FIGS. 3A, 3B, the corresponding blocks may implement the receive circuitry 110 of the master time server 104.

The transmission circuitry 106 includes an ingress side medium access control (MAC) interface 302, a timestamping circuitry 304, a clock 306, egress side physical coding sublayer (PCS) circuitry 308, a physical medium attachment 310, and egress time correction circuitry 312 that includes egress latency tracking circuitry (ELTC) 314, and egress latency correction circuitry (ELCC) 316.

The ingress side MAC interface 302 receives data for transmission (e.g., a time synchronization message) from computing circuitry that generates and/or relays such data. The ingress side MAC interface 302 is connected to the timestamping circuitry 304. The timestamping circuitry 304 is connected to the clock 306, the egress side PCS 308, and the ELCC 316. The egress side PCS 308 is connected to the physical media attachment 310 and the ELTC 314. The physical media attachment 310 is connected to the slave device 116 (e.g., via a network, a cable, etc.).

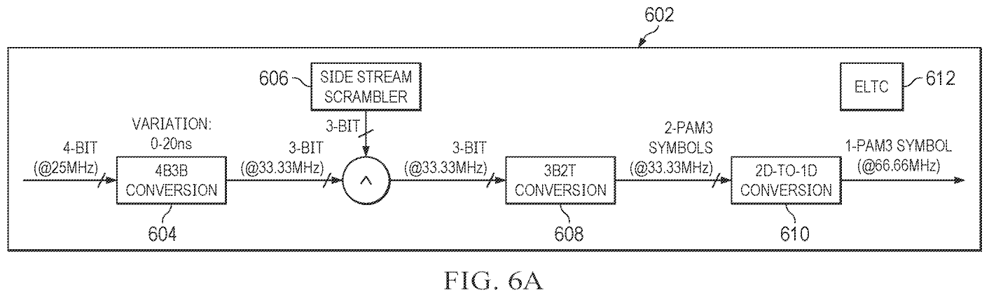

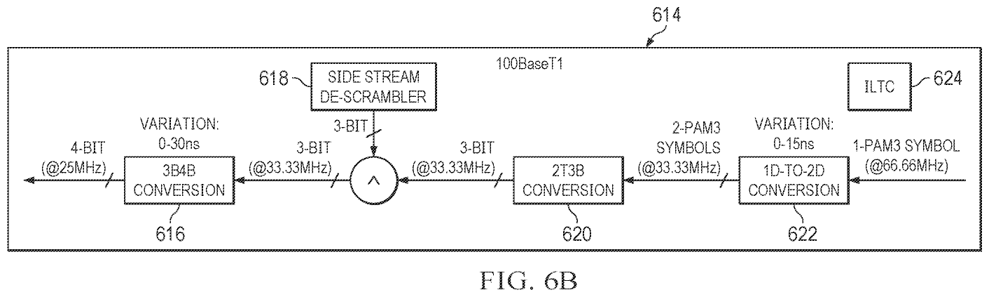

When data is received by the ingress side MAC interface 302, the timestamping circuitry 304 determines a current timestamp from the clock 306. The ELTC 314 of the egress time correction circuitry 312 determines a state of the egress side PCS 308 and determines a projected encoding delay based on the state to provide the projected encoding delay to the ELCC 316. Various states that may be detected are described in conjunction with FIGS. 6A-14.

The ELCC 316 receives the current timestamp from the timestamping circuitry 304 and adjusts the timestamp to compensate for the projected encoding delay. For example, the ELCC 316 adds the delay to the timestamp to determine an adjusted timestamp that is expected to offset the variable portion of the delay introduced by the encoding process. The ELCC 316 may also add a known constant delay to the timestamp to compensate for a known transmission delay when such delay is constant and known. The ELCC 312 provides the adjusted timestamp to the timestamping unit 304 to include the adjusted timestamp in the transmission (e.g., instead of the original current timestamp) (e.g., inserting the timestamp in a time synchronization message).

The egress side PCS 308 encodes the data, and the physical media attachment 310 transmits the encoded data to the slave device 116.

The receive circuitry 118 includes a physical media attachment 318, an ingress side PCS 320, a timestamping unit 324, a clock 326, an egress side MAC interface 328, and ingress time correction circuitry 330, which includes ingress latency tracking circuitry (ILTC) 332, and ingress latency correction circuitry (ILCC) 334.

The physical media attachment 318 receives data from the physical media (e.g., physical media connecting the slave device 116 to the mater time server 104). The physical media attachment 318 is connected to the ingress side PCS 320. The ingress side PCS 320 is connected to the timestamping unit 324 and the ILTC 332. The timestamping unit 324 is connected to the clock 326, the egress side MAC interface 328, and the ILCC 334. The egress side MAC interface 328 provides a decoded received data to other components of the slave device 116.

When data is received by the physical media attachment 318, the physical media attachment 318 provides the data to the ingress PCS 320. The ingress side PCS decodes the received data (e.g., a time synchronization message) and provides the decoded message to the timestamping unit 324. The ILTC 332 determines state information about the ingress side PCS 320 and uses the state information to determine a predicted variable delay for the decoding process. The ILCC 334 receives the current timestamp from the clock 326 via the timestamping unit 324 for the receive time and adjusts the time based on the variable latency determined by the ILTC 332. The ILCC 334 provides the adjusted timestamp to the timestamping unit 324. The timestamping unit 324 provides the decoded received data with the adjusted received timestamp to the egress side MAC interface 328.

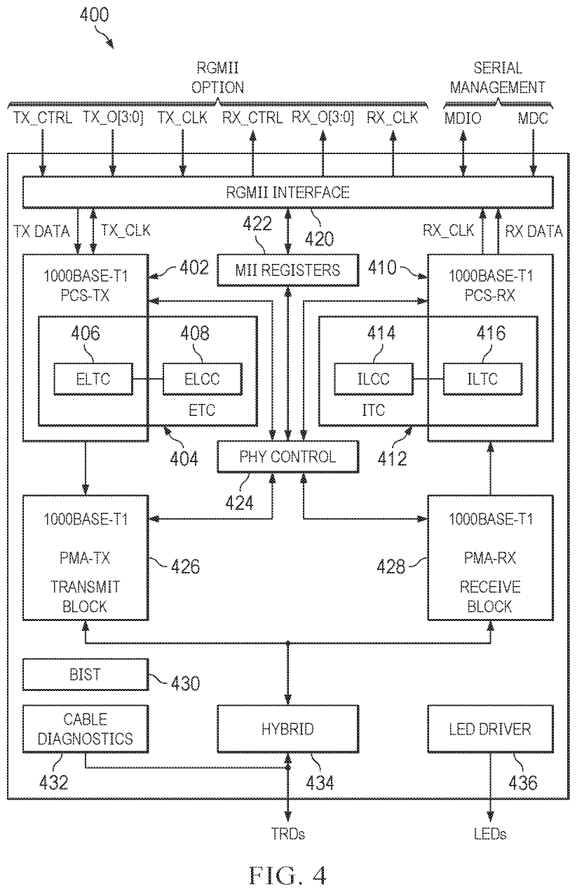

FIG. 4 is a block diagram of an example Ethernet PHY 400. The Ethernet PHY 400 includes a transmit PCS 402, which includes egress time correction circuitry 404 that includes ELTC 406 and ELCC 408. The PHY 400 also includes receive PCS 410 that includes ingress time correction circuitry 412 that includes ILCC 414 and ILTC 416.

The Ethernet PHY 400 may implement the transmission circuitry 106 and the receive circuitry 110 and/or the receive circuitry 118 and the transmission circuitry 122. The Ethernet PHY 400 may implement the transmission circuitry 106 and/or the receive circuitry 118 of FIGS. 3A, 3B. In an example, the ELTC 406 is implemented by the ELTC 314, and the ELCC 408 is implemented by the ELCC 316. In this example, the egress time correction circuitry 404 is implemented by the egress time correction circuitry 312 of FIGS. 3A, 3B, and/or the ingress time correction circuitry 412 is implemented by the ingress time correction circuitry 330 of FIGS. 3A, 3B. Also, in this example, the ILCC 414 is implemented by the ILCC 334, and the ILTC 416 is implemented by the ILTC 332.

According to the illustrated example, the ELTC 406 is implemented within the transmit PCS 402 and is connected to the ELCC 408 that is implemented as separate circuitry from the ELTC 406. Similarly, the ILTC 416 is implemented within the receive PCS 410 and is connected to the ILCC 414 that is implemented as separate circuitry from the ILTC 416. Alternatively, any other combination of implementing the components within a PCS and/or separate from the PCS may be utilized.

The egress time correction circuitry 108, 124, 312, 404 of FIGS. 1, 3, and/or 4 and/or the ingress time correction circuitry 112, 120, 330, 412 of FIGS. 1, 3, and/or 4 may be instantiated (e.g., creating an instance of, bring into being for any length of time, materialize, implement, etc.) by programmable circuitry such as a Central Processor Unit (CPU) executing first instructions. The egress time correction circuitry 108, 124, 312, 404 and/or the ingress time correction circuitry 112, 120, 330, 412 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. Some or all of the circuitry of FIGS. 1, 3, and/or 4 may, thus, be instantiated at the same or different times. Some or all of the circuitry of FIGS. 1, 3, and/or 4 may be instantiated, for example, in one or more threads executing concurrently on hardware and/or in series on hardware.

Moreover, some or all of the circuitry of FIGS. 1, 3, and/or 4 may be implemented by microprocessor circuitry executing instructions and/or FPGA circuitry performing operations to implement one or more virtual machines and/or containers. As used herein, the phrase “logic circuitry is configured to execute instructions to cause the logic circuitry to perform an action” and the equivalent means that the logic circuitry may read the instructions and execute the instructions to perform the action (e.g., a processor executing machine readable instructions) and/or the logic circuitry may be configured with the instructions (e.g., instructions utilized to program an embedded device, instructions utilized to implement an ASIC, instructions utilized to configure an FPGA, etc.).

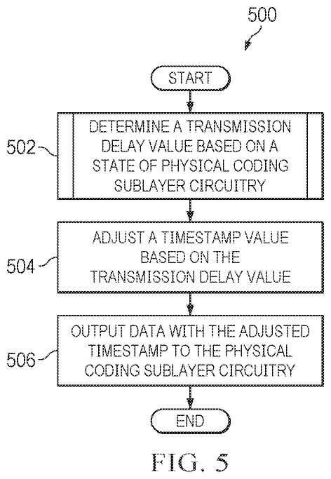

The egress time correction circuitry 108, 124, 312, 404 of FIGS. 1, 3, and/or 4 is instantiated by programmable circuitry executing egress time correction instructions and/or configured to perform operations such as those represented by the flowchart(s) of FIGS. 5, 7, 8, 12, and 14.

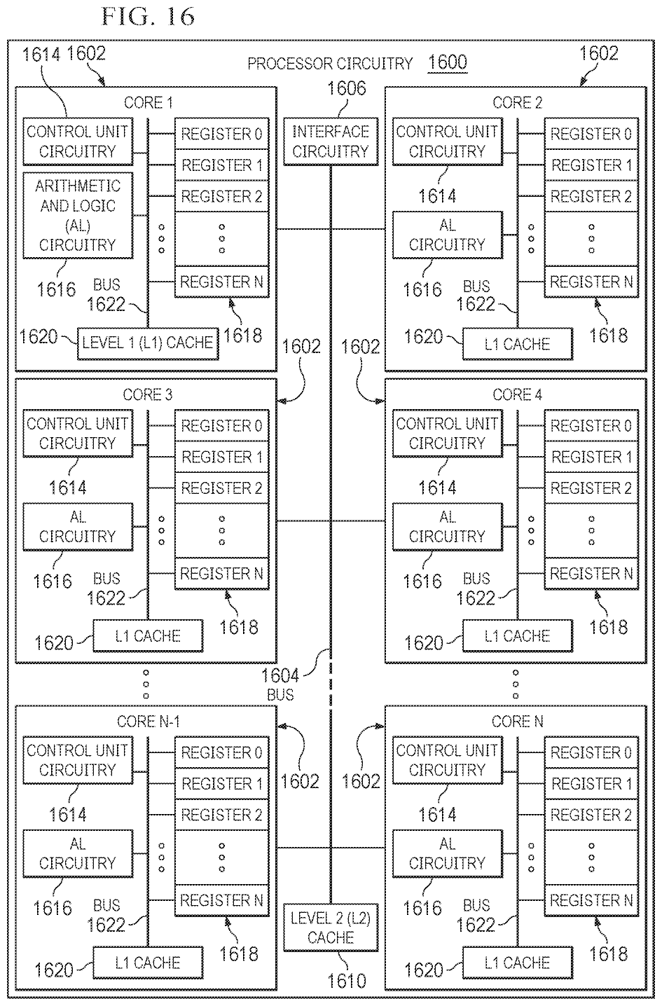

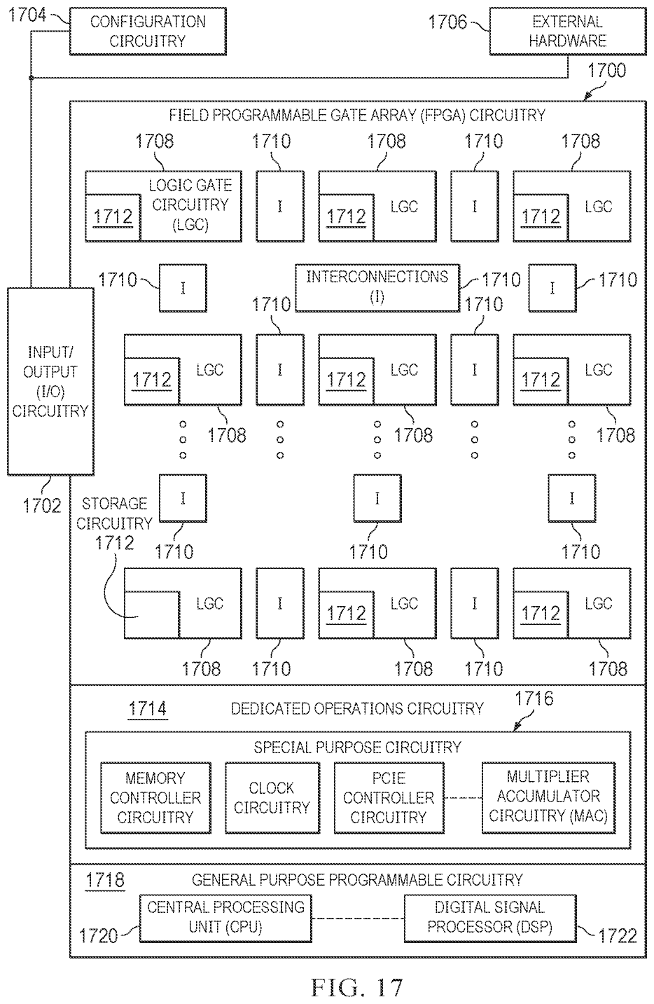

The egress time correction circuitry 108, 124, 312, 404 of FIGS. 1, 3, and/or 4 includes means for correcting timestamps to adjust for variable delays in encoding. The means for correcting may be implemented by egress time correction circuitry 108, 124, 312, 404 of FIGS. 1, 3, and/or 4. The egress time correction circuitry 108, 124, 312, 404 of FIGS. 1, 3, and/or 4 may be instantiated by programmable circuitry such as the programmable circuitry 1512 of FIG. 15. For instance, the egress time correction circuitry 108, 124, 312, 404 of FIGS. 1, 3, and/or 4 may be instantiated by the microprocessor 1600 of FIG. 16 executing machine executable instructions such as those implemented by at least FIGS. 5, 7, 8, 12, and 14.

The example Ethernet PHY 400 also includes a media independent interface 420 (e.g., a reduced gigabit media independent interface) to communicatively couple the Ethernet PHY 400 to a computing device (e.g., via an interface). The media independent interface 420 is also connected to the example transmit PCS 402 (for transmission of communications from the transmit PCS 402 to a network) and the example receive PCS 410 (for receipt of communications from the network by the receive PCS 402). The media independent interface 420 is further connected to a set of media independent registers 422 for storing various control settings, parameters, and management values.

The example Ethernet PHY 400 includes a PHY control 424 that is connected to the media independent registers 422, the transmit PCS 402, the receive PCS 404, a physical media attachment (PMA) transmit block 426, and a PMA receive block 428. The PHY control 424 directs operation of the connected blocks and controls operation of the Ethernet PHY 400. The PMA transmit block 426 and the PMA receive block 428 are connected to a hybrid block 434 to couple the Ethernet PHY with incoming signals for network transmission from transmit and receive data lines (TRDs). The example Ethernet PHY 400 includes a built in self-test circuit (BIST) 430 to perform self-testing of the Ethernet PHY 400. The example Ethernet PHY 400 includes an example cable diagnostics block 432 coupled to the incoming TRDs to perform diagnostics of network cables coupled to the example Ethernet PHY 400. The example Ethernet PHY 400 also includes an LED driver 436 to operate output light emitting diodes (LEDs) (e.g., status LEDs).

The egress time correction circuitry 108, 124, 312, 404 of FIGS. 1, 3, and/or 4 may be instantiated by hardware logic circuitry, which may be implemented by an ASIC, XPU, or the FPGA circuitry 1700 of FIG. 17 configured and/or structured to perform operations corresponding to the machine readable instructions. The egress time correction circuitry 108, 124, 312, 404 of FIGS. 1, 3, and/or 4 may be instantiated by any other combination of hardware, software, and/or firmware. For example, the egress time correction circuitry 108, 124, 312, 404 of FIGS. 1, 3, and/or 4 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The means for correcting includes means for egress latency tracking and egress latency correction. The ingress time correction circuitry 112, 120, 330, 412 of FIGS. 1, 3, and/or 4 is instantiated by programmable circuitry executing egress time correction instructions and/or configured to perform operations such as those represented by the flowchart(s) of FIGS. 5, 7, 8, 12, and 14. The ingress time correction circuitry 112, 120, 330, 412 of FIGS. 1, 3, and/or 4 includes means for correcting timestamps to adjust for variable delays in decoding. The means for correcting may be implemented by ingress time correction circuitry 112, 120, 330, 412 of FIGS. 1, 3, and/or 4.

The ingress time correction circuitry 112, 120, 330, 412 of FIGS. 1, 3, and/or 4 may be instantiated by programmable circuitry such as the programmable circuitry 1512 of FIG. 15. For instance, the ingress time correction circuitry 112, 120, 330, 412 of FIGS. 1, 3, and/or 4 may be instantiated by the microprocessor 1600 of FIG. 16 executing machine executable instructions such as those implemented by at least FIGS. 5, 7, 8, 12, and 14. The ingress time correction circuitry 112, 120, 330, 412 of FIGS. 1, 3, and/or 4 may be instantiated by hardware logic circuitry, which may be implemented by an ASIC, XPU, or the FPGA circuitry 1700 of FIG. 17 configured and/or structured to perform operations corresponding to the machine readable instructions. The ingress time correction circuitry 112, 120, 330, 412 of FIGS. 1, 3, and/or 4 may be instantiated by any other combination of hardware, software, and/or firmware. The ingress time correction circuitry 112, 120, 330, 412 of FIGS. 1, 3, and/or 4 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The means for correcting includes means for ingress latency tracking and ingress latency correction.

While example manners of implementing the egress time correction circuitry 108, 124, 312, 404 of FIGS. 1, 3, and/or 4 and/or the ingress time correction circuitry 112, 120, 330, 412 of FIGS. 1, 3, and/or 4 are illustrated in FIGS. 1, 3, and/or 4, one or more of the elements, processes, and/or devices illustrated in FIGS. 1, 3, and/or 4 may be combined, divided, re-arranged, omitted, eliminated, and/or implemented in any other way. Further, the egress time correction circuitry 108, the ingress time correction circuitry 112, the ingress time correction circuitry 120, and/or the egress time correction circuitry 124, the ELTC 314, the ELCC 316, the ILTC 332, and/or the ILCC 334 of FIG. 4, the ELTC 406, the ELCC 408, the ILCC 414, and/or the ILTC 416 of FIG. 4, and/or more generally the Ethernet PHY 400 of FIG. 4, may be implemented by hardware alone or by hardware in combination with software and/or firmware.

Thus, for example, any of the egress time correction circuitry 108, the ingress time correction circuitry 112, the ingress time correction circuitry 120, and/or the egress time correction circuitry 124, the ELTC 314, the ELCC 316, the ILTC 332, and/or the ILCC 334 of FIG. 4, the ELTC 406, the ELCC 408, the ILCC 414, and/or the ILTC 416 of FIG. 4, and/or more generally the Ethernet PHY 400 of FIG. 4, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the egress time correction circuitry 108, 124, 312, 404 of FIGS. 1, 3, and/or 4 and/or the ingress time correction circuitry 112, 120, 330, 412 of FIGS. 1, 3, and/or 4 may include one or more elements, processes, and/or devices in addition to, or instead of, those illustrated in FIGS. 1, 3, and/or 4, and/or may include more than one of any or all of the illustrated elements, processes and devices.

Flowchart(s) representative of example machine readable instructions, which may be executed by programmable circuitry to implement and/or instantiate the egress time correction circuitry 108, 124, 312, 404 of FIGS. 1, 3, and/or 4 and/or the ingress time correction circuitry 112, 120, 330, 412 of FIGS. 1, 3, and/or 4 and/or representative of example operations which may be performed by programmable circuitry to implement and/or instantiate the egress time correction circuitry 108, 124, 312, 404 of FIGS. 1, 3, and/or 4 and/or the ingress time correction circuitry 112, 120, 330, 412 of FIGS. 1, 3, and/or 4, are shown in FIGS. 5, 7, 8, 12, and 14. The machine readable instructions may be one or more executable programs or portion(s) of one or more executable programs for execution by programmable circuitry such as the programmable circuitry 1512 shown in the processor platform 1500 described below in connection with FIG. 15 and/or may be one or more function(s) or portion(s) of functions to be performed by the programmable circuitry (e.g., an FPGA) described below in connection with FIGS. 16 and/or 17. The machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums.

Further, although the program is described with reference to the flowchart(s) illustrated in FIGS. 5, 7, 8, 12, and 14, many other methods of implementing the egress time correction circuitry 108, 124, 312, 404 of FIGS. 1, 3, and/or 4 and/or the ingress time correction circuitry 112, 120, 330, 412 of FIGS. 1, 3, and/or 4 may alternatively be used. The order of execution of the blocks of the flowchart(s) may be changed, and/or some of the blocks described may be changed, eliminated, or combined. Any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.).

The machine readable instructions may require one or more of installation, modification, adaptation, updating, combining, supplementing, configuring, decryption, decompression, unpacking, distribution, reassignment, compilation, etc., to be directly read, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions are stored in a state in which they are read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. The machine readable instructions may be represented using any of the following languages: C, C++, Java, C#, Perl, Python, JavaScript, HyperText Markup Language (HTML), Structured Query Language (SQL), Swift, etc.

As mentioned above, the operations of FIGS. 5, 7, 8, 12, and 14 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information).

FIG. 5 is a flowchart representative of example machine readable instructions and/or example operations 500 executed, instantiated, and/or performed by programmable circuitry to adjust a timestamp based on a state of physical coding sublayer circuitry (e.g., the egress PCS 308, the ingress PCS 320, the transmission PCS 402 and/or the receive PCS 410). The machine-readable instructions and/or the operations 500 of FIG. 5 begin at block 502, at which the ELTC 314, the ILTC 332, the ELTC 406, and/or the ILTC 416 determines a delay (e.g., a variable encoding delay and/or a variable decoding delay) based on a state of the PCS circuitry (e.g., encoder circuitry, decoder circuitry, etc.). For example, as illustrated in FIGS. 6A-14, the state is a state of one or more clock signals (e.g., a relative state of two different clock signals), a particular path through the PCS (e.g., a path through a multiplexer), a particular block index of a transmission frame, etc.

The ELCC 316, the ILCC 334, the ELCC 408, and/or the ILCC 414 then adjusts a timestamp value to compensate for the determined delay (e.g., adds the delay time to the timestamp or subtracts the delay from the timestamp) (block 504). The ELCC 316, the ILCC 334, the ELCC 408, and/or the ILCC 414 then outputs the adjusted timestamp (e.g., to the egress PCS 308, the ingress PCS 320, the transmission PCS 402 and/or the receive PCS 410, respectively) for association with data that is either transmitted or received (block 506). For example, the adjusted timestamp compensates for the variable portion of delay by a PCS that may otherwise interfere with a precise timestamping process. The corrected timestamps may be utilized as part of a clock adjustment process to cause adjustment of a clock of a slave device to synchronize the clock of a slave device (e.g., the slave device 116) with a clock of a master time server (e.g., the master time server 104).

While FIG. 5 illustrates a single flow through determining a delay and adjusting a timestamp, the process may be repeated for each message to be transmitted. The adjustment associated with two different messages may be determined based on a variable delay that changes among at least some of the messages. According to the illustrated example, the delay is determined as each message is to be transmitted. Alternatively, a first delay and adjustment may be determined for first multiple messages, symbols, blocks, frames, etc. and then a second delay and adjustment may be determined for a second multiple messages, symbols, blocks, frames, etc. In an example of multiple runs of the instructions of FIG. 5 to account for multiple transmission (e.g., a first transmission and a second transmission), the ELTC 314, the ILTC 332, the ELTC 406, and/or the ILTC 416 determines a first delay (e.g., a variable encoding delay and/or a variable decoding delay) introduced by the PCS 402 at a first time. The ELTC 314, the ILTC 332, the ELTC 406, and/or the ILTC 416 adjust a first timestamp associated with a first transmission based on the first delay. In the example, the first timestamp is transmitted with the first transmission. The ELCC 316, the ILCC 334, the ELCC 408, and/or the ILCC 414 then adjusts a first timestamp associated with a first transmission based on the first delay, the first timestamp transmitted with the first transmission. The ELTC 314, the ILTC 332, the ELTC 406, and/or the ILTC 416, later, determines a second delay introduced by the PCS 402 at a second time, where the second delay different than the first delay (e.g., because the state of the PCS 402 at the first time is different than the state of the PCS at the second time). The ELCC 316, the ILCC 334, the ELCC 408, and/or the ILCC 414 then adjusts a second timestamp associated with a second transmission based on the second delay, the second timestamp transmitted with the second transmission.

For example, the adjusted timestamp is then used for a transmission so that a receiver of the transmission will receive a timestamp that does not include a variable delay (e.g., only a transmission delay). For example, as illustrated in FIG. 2, the after the slave device 116 receives the delay_resp 208, the slave device 116 has a set of timestamps that have been adjusted (e.g., adjusted by the master time server 104 and the slave device 116) to offset the variable delay introduced by various components in the transmission (e.g., by components of a PCS). Accordingly, the slave device 116 may use the adjusted timestamps to determine an amount of time to adjust a local clock of the slave device 116 to synchronize that clock with a clock of the master time server 104. The amount of time to adjust the clock can be calculated as a difference between a first timestamp corresponding to time and a second timestamp. In particular, as described in conjunction with FIG. 2, the slave device 116 may calculate the amount of time to adjust the clock based on multiple timestamps, such as: ½ (t₂′−t₁′−t₄′-t₃′).

FIG. 6A is a block diagram of an example transmission PCS 602, and FIG. 6B is a block diagram of an example receive PCS 614. The PCS 602 and 614 are illustrated to facilitate description of particular components that may cause variable delays (e.g., rather than static, consistent, stable, etc. delays) during operation.

The transmission PCS 602 includes a 4 bit to 3 bit (4B3B) conversion 604, a side stream scrambler 606, a 3 bit to ternary (3B2T) conversion, a 2 dimension to 1 dimension (2D-to-1d) conversion 610, and ELTC 612. The 4B3B conversion 604 receives a 4 bit data and outputs a 3 bit data to be adjusted by the side scrambler 606. The adjusted 3 bit data adjusted by the side stream scrambler 606 is input to the 3B2T 608. The output of the 3B2T 608 is connected to the 2D-to-1D conversion 610, which outputs an encoded data for transmission. The ELTC 612 monitors the state of the PCS 602 during operation. While not shown in FIG. 6, the ELTC 612 is connected to an ELCC to perform timestamp adjustment. The ELTC 612 may be implemented by the ELTC 314 of FIGS. 3A, 3B and/or the ELTC 406 of FIG. 4.

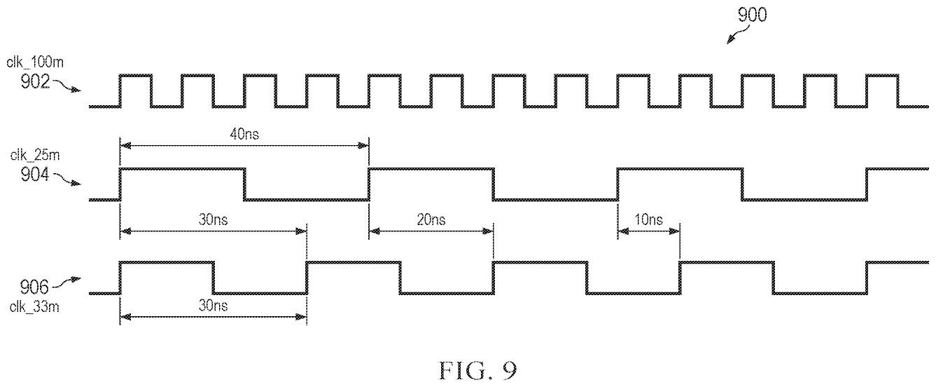

In the illustrated example, the 4B3B 604 results in a delay that varies between 10 nanoseconds and 30 nanoseconds as illustrated in FIG. 9. Accordingly, the ELTC 612 monitors the state of the 4B3B conversion 604 to determine the particular delay that is present at a time of transmission of data. In this example, components of the PCS 602 other than the 4B3B conversion 604 do not have variable delays and, thus, are not described further. However, the described techniques may be similarly used to account for latency caused by or otherwise associated with other components of the PCS 602.

The PCS 614 includes a 3 bit to 4 bit (3B4B) conversion, a side stream de-scrambler 618, a Ternary to 3 bit conversion (2T3B) 620, a 1 dimension to 2 dimension conversion (1D-to-2D) 622, and ILTC 624. The 1D-to-2D conversion 622 receives incoming symbol data and outputs a converted 2 dimension data to the 2T3B 620, the 2T3B conversion outputs a 3 bit data to be descrambled by the side stream descrambler 618, which is converted from 3 bits to 4 bits by the 3B4B 616. The ILTC 624 monitors the state of the PCS 614 during operation. While not shown in FIG. 6, the ILTC 624 is connected to an ILCC to perform timestamp adjustment. The ILTC 624 may be implemented by the ILTC 332 of FIGS. 3A, 3B and/or the ILTC 416 of FIG. 4.

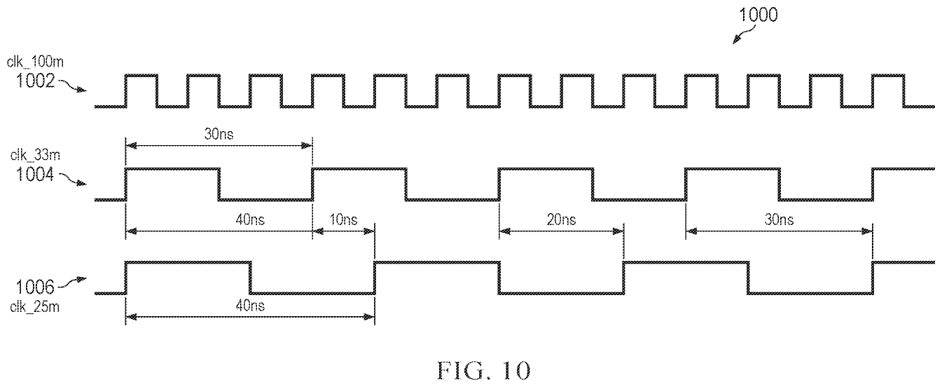

In the illustrated example, the 3B4B 616 results in a delay that varies between 10 nanoseconds and 40 nanoseconds as illustrated in FIG. 10. The 1D-to-2D 622 causes a delay that varies between 0 nanoseconds and 15 nanoseconds (e.g., an amount of time associated with delaying one symbol transmission). Accordingly, the ILTC 624 monitors the state of the 3B4B conversion 616 and the 1D-to-2D 622 to determine the particular delay that is present at a time of receiving data. The components of the PCS 614 other than the 3B4B conversion 616 and the 1D-to-2D 622 do not have variable delays and, thus, are not described further. However, the described techniques may be similarly used to account for latency caused by or otherwise associated with other components of the PCS 614.

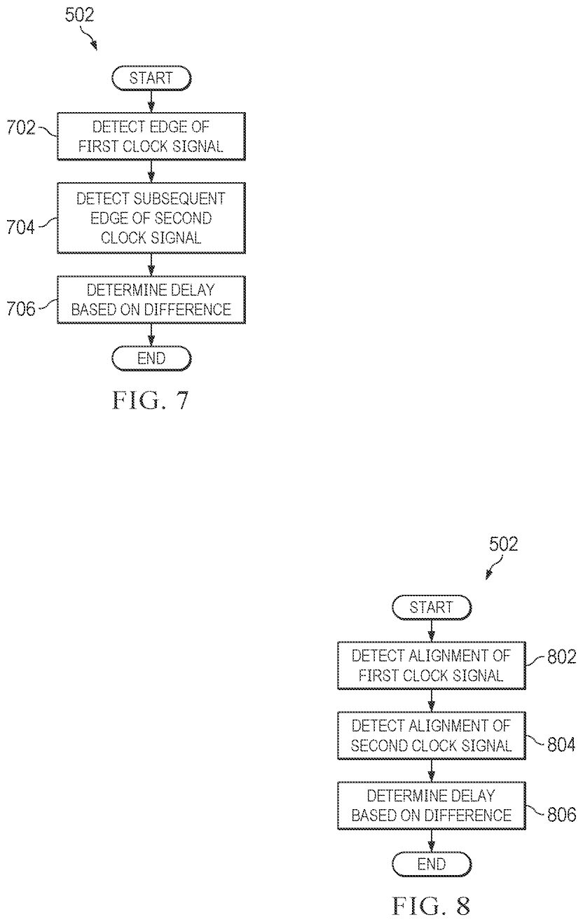

FIG. 7 is a flowchart of an example implementation of block 502 to detect clock signals that cause variable delays in a PCS. For example, a bit level conversion circuitry converts a transmission/communication at a first bit level (e.g., 2-bit, 3-bit, 4-bit, etc.) to a different bit level such as in the 4B3B 604 (e.g., a first bit level conversion) and/or the 3B4B 616 (e.g., a second bit level conversion). The ELTC 314 and/or the ILTC 332 detects an edge of a first clock signal (block 702) and detects a second edge of a second clock signal (block 704). For example, a bit level converter has a base clock signal (e.g., 100 MHz clock signal) that is utilized to generate a first clock signal (e.g., 25 MHz) and is utilized to generate a second clock signal (e.g., 33 MHz). In the example, the ELTC 314 and/or the ILTC 332 accesses the first and second clock signals to determine their phase alignment with respect to each other.

The ELTC 314 and/or the ILTC 332 determines a delay based on the difference (block 706). According to the example, the ELTC 314 and/or the ILTC 332 determines the delay as the difference between rising edge of the first clock signal and the next rising edge of the second clock signal. For instance, if the rising edge of the first clock signal and the rising edge of the second clock signal happen at the same time, the rising edge of the second clock signal is not considered the next rising edge. The difference between the rising edges may be determined by observing the current state of the clock signals. Another approach for determining the difference is tracking a historical state of the clock signals (e.g., because the clock signals are synchronous and deterministic an upcoming difference between the rising edges can be determined based on a prior alignment of the rising edges).

After operation of FIG. 7, control returns to block 504 of FIG. 5 based on the delay determined in FIG. 8.

FIG. 8 is a flowchart of another example implementation of block 502 to detect clock signals that cause variable delays in a PCS, e.g., in the 4B3B 604 and/or the 3B4B 616. The ELTC 314 and/or the ILTC 332 determines an alignment of a first clock signal relative to a base clock signal (block 802) and an alignment of a second clock signal relative to the base clock signal (block 804). The ELTC 314 and/or the ILTC 332 then determines a delay based on a difference between the alignment of the clock signals. For example, the ELTC 314 and/or the ILTC 332 determine a phase of a first clock signal and a phrase of a second clock signal and determine a delay based on what the state of the clock signals will be during transmission of data to be timestamped (block 806).

After operation of FIG. 8, control returns to block 504 of FIG. 5 to adjust a timestamp value based on the delay determined in FIG. 8.

FIG. 9 illustrates several clock signals 900 that are utilized to drive operation of a bit level converter. The example clock signals includes a base clock signal 902 at 100 MHz, a first clock signal at 25 MHz 904 derived from rising edges of the base clock signal 902, and a second clock signal at 33 MHz 906 derived from rising edges of the base clock signal 902. For example, the 4B3B conversion 604 utilizes the first clock signal 904 to read a next 4 bits of data and the second clock signal 906 to output a next 3 bits of data to effectively convert an incoming signal of 4 bits at 25 MHz to an outgoing signal of 3 bits at 33 MHz. Because the clock signals operate at different frequencies, their rising edges, which drive operation, do not align. A signal passing through the converter is delayed for the amount of time that passes between the rising edge of the first clock signal 904 and the rising edge of the second clock signal 906. Accordingly, by analyzing the clock signals as set forth in FIGS. 7 and/or 8, the delay introduced by the converter can be determined/predicted and, as set forth in FIG. 5, the delay can be compensated-for by adjusting a timestamp (e.g., by increasing the timestamp for the amount of time introduced by the delay so that the delay is offset).

As illustrated by the clock signals 900 of FIG. 9 of the 4B3B 604, in a first instance the relative location of the edges of the 25 MHz clock signal and the 33 MHz clock edges indicates that the delay between a rising edge of the 25 MHz clock signal and a next (in time) rising edge of the 33 MHz clock signal may be 30 nanoseconds, 20 nanoseconds, and/or 10 nanoseconds depending on the relative timing. Similarly, according the process of FIG. 8, by knowing the phases of the 25 MHz clock signal and the 33 MHz clock signal, the future alignment between the clock signals and, thus, the variable delay at a future time can be determined. As illustrated by FIG. 9, clock signals operating at 25 MHz and 33 MHz have a phase difference of 10 nanoseconds so they are constantly varying their relative alignment, but the difference in alignment is deterministically always one of three different values (e.g., 30 nanoseconds, 20 nanoseconds, or 10 nanoseconds). Clock signals that utilize other frequencies may encounter different alignment differences as well as different number of alignment differences. The rising edges and/or the phases of the signals may be determined by the ELTC 314 and/or the ILTC 332 monitoring the state of a 100 MHz clock signal from which other clock signals are derived. In such an example, the predictable nature of the clock signals generated from the 100 MHz clock signal allows for determination of the state of the other clock signals at a given time. For example, as shown in FIG. 9, if the rising edge of the first clock signal 904 occurs at the same time as the rising edge of the second clock signal 906 at a first time, it can be predicted that after the next rising edge of the first clock signal 904, the second clock signal 906 will have a rising edge that is 20 nanoseconds later.

Turning to FIG. 10, the block signals 1000 of the 3B4B 616 are illustrated. While the same principle of recognizing the edges and/or phases of the clock signals 1000 may be utilized for determining the delay, as illustrated, the actual delays are different and the delay may be 10 nanoseconds, 20 nanoseconds, 30 nanoseconds, or 40 nanoseconds. For example, the clock signals 1000 include a base clock signal 1002 at 100 MHz, a first clock signal 1004 at 33 MHz, and a second clock signal 1006 at 25 MHz. Because the first clock signal 904 is associated with taking in an input value (e.g., 3 bits of data at 33 MHz), the delay of the associated converter (e.g., the 3B4B conversion 616) is the difference between the rising edge of the first clock signal 904 and the next (in time) rising edge of the second clock signal 906.

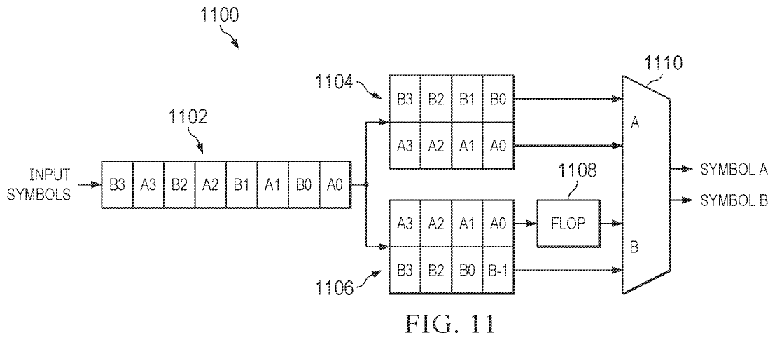

Turning to FIG. 11, a different type of delay is introduced by the message flow 1100. The example message flow 1100 facilitates conversion of a 1 bit signal into a 2 bit signal (e.g., in the 1D-to-2D conversion 622). Rather than a delay resulting from a difference between an input clock and an output clock, the flow 1100 causes a variable delay because some symbols 1102 follow a first path 1104 that has 0 variable delay and some symbols follow a second path 1106 that introduces 15 nanoseconds delay. The particular path is selected by control of the multiplexer 1110. In other words, the first path 1104 and the second path 1106 are utilized by the multiplexer 1110 to selectively control whether a delay (provided by the flop 1108) is introduced to control the alignment of the 2 bit signal output by the multiplexer 1110. According to the illustrated example of FIG. 11, some symbol ordering needs correction and thus, a flop 1108 or other type of delay is provided along the second path 1106 through the multiplexer 1110 to force the realignment. For instance, the delay of 15 nanoseconds causes symbol A0, which is initially not aligned with symbol B0, to be aligned with symbol B0. The symbol ordering and determination of whether correction needs to be applied may be determined by attempting to descramble the resulting signal to determine if descrambling is successful (e.g., by the side stream de-scrambler 618). If the side stream de-scrambler 618 determines that de-scrambling is not successful because the corresponding symbol (e.g., A0 and B0) are not aligned in a single cycle, the side stream de-scrambler 618 controls the multiplexer 1110 to select the second path 1106 to correct the misalignment. By detecting the state of the multiplexer 1110 and/or the signal controlling the multiplexer 1110, the variable delay introduced by the converter can be determined. In this example, the variable delay is 0 nanoseconds if the first path 1104 is selected and 15 nanoseconds if the second path 1106 is selected.

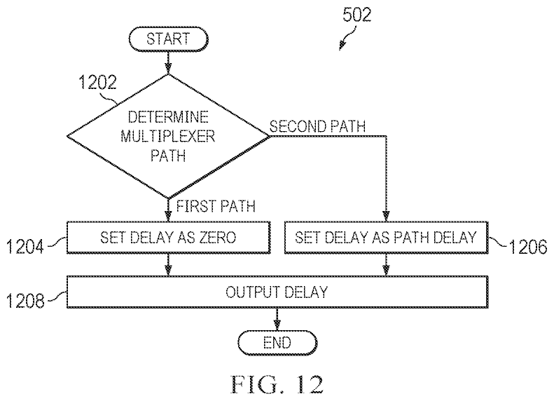

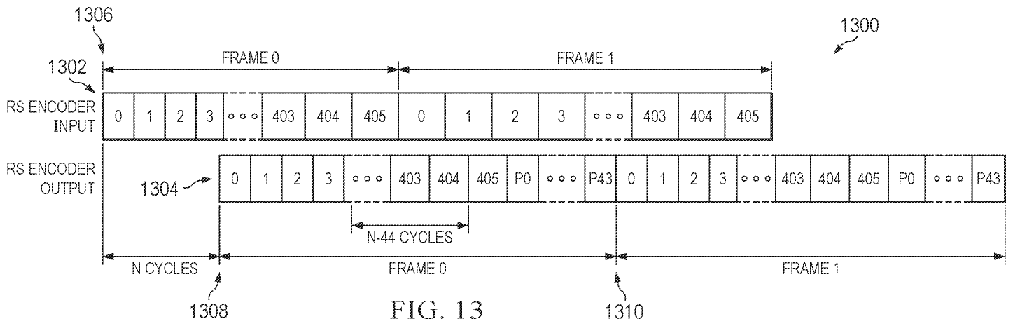

FIG. 12 is a flowchart of an example implementation of block 502 or detecting a delay resulting from the selection of various symbol transmission paths that may have variable delays.

The ELTC 314 and/or the ILTC 332 determines a path that a set of symbols will take through a multiplexer by examining a current symbol ordering (block 1212). The ELTC 314 and/or the ILTC 332 may detect the state of the multiplexer 1110 and/or the signal controlling the multiplexer 1110 (e.g., from the side stream de-scrambler 618) to determine which path is selected. For example, the ELTC 314 and/or the ILTC 332 determine that the symbol ordering allows the symbols to traverse through a path that doesn't include a delay and/or determine that the symbol ordering needs to be corrected and. Thus, the symbols will traverse through a path that includes a delay.

When the ELTC 314 and/or the ILTC 332 determines that a first path that does not include a delay is selected (block 1202), the ELTC 314 and/or the ILTC 332 determine the variable delay to be zero (block 1204). When the ELTC 314 and/or the ILTC 332 determines that a second path that includes a delay is selected (block 1206), the ELTC 314 and/or the ILTC 332 determine the variable delay to be the path delay (e.g., 15 nanoseconds) (block 1206). After the ELTC 314 and/or the ILTC 332 determines the delay, the ELTC 314 and/or the ILTC 332 outputs the delay to be used to adjust a timestamp value to offset the delay (e.g., when control returns to block 504) (block 1208).

FIG. 13 illustrates yet another type of variable delay that may occur during encoding and/or decoding. The input symbols 1302 and output symbols 1304 1300 of FIG. 13 illustrate the input and output of an example Reed Solomon (RS) Forward Error Correction (FEC) process. Such a process may be employed by a reed-Solomon error correction circuitry of the PCS. The RS FEC may be implemented by error correction circuitry of the PCS such as an error correction encoder circuitry, an error correction decoder circuitry, etc. The 1000BaseT1 standard uses RS Encoding for FEC with a block size of 406 symbols and 44 parity symbols. Such an encoding process introduces a variable delay. As illustrated in FIG. 13, the delay of the first symbol 0 (from input 1302 to output 1304) is the time from first time 1306 to second time 1308 (e.g., some N cycles). However, the block encoding of the encoder results in each symbol having slightly less delay until the delay for the last symbol in the frame is 44 cycles less than the delay of the first symbol (e.g., the last symbol 405 has a delay of N-44 cycles).

Alternatively, other approaches may utilize other numbers of symbols. The nature of the block encoding causes variable latency of each symbol from input to an RS-encoder to output of the RS-encoder and the decoder. For example, the latency of each symbol in a frame gradually reduces with the last symbol in the frame seeing 44 cycles (or however many parity symbols are utilized) less than the first symbol. In other words, the latency or delay is based on a relative position of the symbol to be transmitted with respect to the start of frame.

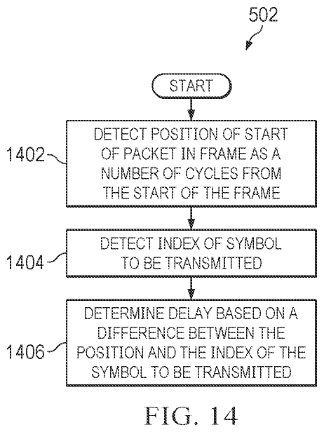

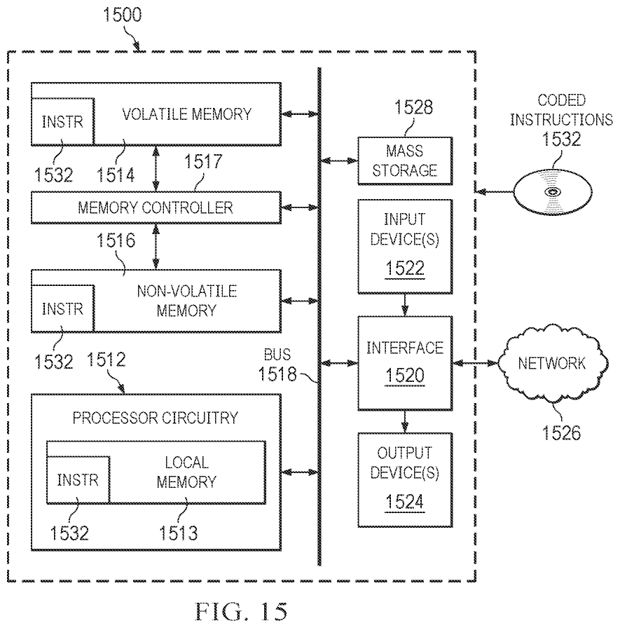

FIG. 14 is a flowchart of an example implementation of block 502 of FIG. 5 to determine a delay associated with the encoding and/or decoding illustrated by FIG. 13. The ELTC 314 and/or the ILTC 332 detects a position of a Start of Packet (e.g., the difference between time 1306 and time 1308) in a frame as a number of cycles from the start of the frame (e.g., N cycles) (block 1402). The ELTC 314 and/or the ILTC 332 then detects an index of a symbol to be transmitted at the time that the timestamp adjustment is to be determined (block 1404). The ELTC 314 and/or the ILTC 332 then determines a delay based on a difference between the position and the index of the symbol to be transmitted (block 1406). Accordingly, because the ELTC 314 and/or the ILTC 332 can determine the position of a symbol to be transmitted, the ELTC 314 and/or the ILTC 332 can determine a delay based on the initial delay from the start of the input symbols 1302 to the start of the output symbols 1304 and the particular symbol index. For example, the delay varies from A) a delay equal to the number of cycles between the encoder/decoder input and the start of an output frame to B) a delay equal to that number of cycles minus 44 cycles for the last symbol in the frame.

FIG. 15 is a block diagram of an example programmable circuitry platform 1500 structured to execute and/or instantiate the machine-readable instructions and/or the operations of FIGS. 5, 7, 8, 12, and 14 to implement the egress time correction circuitry 108, 124, 312, 404 of FIGS. 1, 3, and/or 4 and/or the ingress time correction circuitry 112, 120, 330, 412 of FIGS. 1, 3, and/or 4. The programmable circuitry platform 1500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1500 of the illustrated example includes programmable circuitry 1512. The programmable circuitry 1512 of the illustrated example is hardware. For example, the programmable circuitry 1512 can be implemented by one or more integrated circuits, logic circuits, FPGAs, microprocessors, CPUs, GPUs, DSPs, and/or microcontrollers from any desired family or manufacturer. The programmable circuitry 1512 may be implemented by one or more semiconductor based (e.g., silicon based) devices. In this example, the programmable circuitry 1512 implements, for example, the ELTC 314, the ELCC 316, the ILTC 332, and the ILCC 334.

The programmable circuitry 1512 of the illustrated example includes a local memory 1513 (e.g., a cache, registers, etc.). The programmable circuitry 1512 of the illustrated example is in communication with main memory 1514, 1516, which includes a volatile memory 1514 and a non-volatile memory 1516, by a bus 1518. The volatile memory 1514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1516 may be implemented by flash memory and/or any other desired type of memory device. Access to the main memory 1514, 1516 of the illustrated example is controlled by a memory controller 1517. The memory controller 1517 may be implemented by one or more integrated circuits, logic circuits, microcontrollers from any desired family or manufacturer, or any other type of circuitry to manage the flow of data going to and from the main memory 1514, 1516.

The programmable circuitry platform 1500 of the illustrated example also includes interface circuitry 1520. The interface circuitry 1520 may be implemented by hardware in any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. According to the illustrated example, the interface circuitry 1520 implements network interface circuitry such as network interface circuitry of the master time server 104, of the transmission circuitry 106, of the egress time correction circuitry 108, of the receive circuitry 110, of the ingress time correction circuitry 112, of the slave device 116, of the receive circuitry 118, of the ingress time correction circuitry 120, of the transmission circuitry 122, and/or of the egress time correction circuitry 124.

In the illustrated example, one or more input devices 1522 are connected to the interface circuitry 1520. The input device(s) 1522 permit(s) a user (e.g., a human user, a machine user, etc.) to enter data and/or commands into the programmable circuitry 1512. The input device(s) 1522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1524 are also connected to the interface circuitry 1520 of the illustrated example. The output device(s) 1524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1520 of the illustrated example includes a graphics driver card, a graphics driver chip, and/or graphics processor circuitry such as a GPU.

The interface circuitry 1520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1500 of the illustrated example also includes one or more mass storage discs or devices 1528 to store firmware, software, and/or data. Examples of such mass storage discs or devices 1528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1532, which may be implemented by the machine readable instructions of FIGS. 5, 7, 8, 12, and 14, may be stored in the mass storage device 1528, in the volatile memory 1514, in the non-volatile memory 1516, and/or on at least one non-transitory computer readable storage medium such as a CD or DVD which may be removable.

FIG. 16 is a block diagram of an example implementation of the programmable circuitry 1512 of FIG. 15. In this example, the programmable circuitry 1512 of FIG. 15 is implemented by a microprocessor 1600. The microprocessor 1600 may be a general-purpose microprocessor (e.g., general-purpose microprocessor circuitry). The microprocessor 1600 executes some or all of the machine-readable instructions of the flowcharts of FIGS. 5, 7, 8, 12, and 14 to effectively instantiate the circuitry of FIG. 2 as logic circuits to perform operations corresponding to those machine readable instructions. In some such examples, the circuitry of FIG. 1 and/or FIGS. 3A, 3B is instantiated by the hardware circuits of the microprocessor 1600 in combination with the machine-readable instructions. The microprocessor 1600 may be implemented by multi-core hardware circuitry such as a CPU, a DSP, a GPU, an XPU, etc. Although it may include any number of cores 1602 (e.g., 1 core), the microprocessor 1600 of this example is a multi-core semiconductor device including N cores. The cores 1602 of the microprocessor 1600 may operate independently or may cooperate to execute machine readable instructions. Machine code corresponding to a firmware program, an embedded software program, or a software program may be executed by one of the cores 1602 or may be executed by multiple ones of the cores 1602 at the same or different times. The machine code corresponding to the firmware program, the embedded software program, or the software program is split into threads and executed in parallel by two or more of the cores 1602. The software program may correspond to a portion or all of the machine readable instructions and/or operations represented by the flowcharts of FIGS. 5, 7, 8, 12, and 14.

The cores 1602 may communicate by a first bus 1604. The first bus 1604 may be implemented by a communication bus to effectuate communication associated with one(s) of the cores 1602. The first bus 1604 may be implemented by at least one of an Inter-Integrated Circuit (I2C) bus, a Serial Peripheral Interface (SPI) bus, a PCI bus, or a PCIe bus. The first bus 1604 may be implemented by any other type of computing or electrical bus. The cores 1602 may obtain data, instructions, and/or signals from one or more external devices by interface circuitry 1606. The cores 1602 may output data, instructions, and/or signals to the one or more external devices by the interface circuitry 1606. Although the cores 1602 of this example include local memory 1620 (e.g., Level 1 (L1) cache that may be split into an L1 data cache and an L1 instruction cache), the microprocessor 1600 also includes shared memory 1610 that may be shared by the cores (e.g., Level 2 (L2 cache)) for high-speed access to data and/or instructions. Data and/or instructions may be transferred (e.g., shared) by writing to and/or reading from the shared memory 1610. The local memory 1620 of each of the cores 1602 and the shared memory 1610 may be part of a hierarchy of storage devices including multiple levels of cache memory and the main memory (e.g., the main memory 1514, 1516 of FIG. 15).Higher levels of memory in the hierarchy may exhibit lower access time and have smaller storage capacity than lower levels of memory. Changes in the various levels of the cache hierarchy are managed (e.g., coordinated) by a cache coherency policy.

Each core 1602 may be referred to as a CPU, DSP, GPU, etc., or any other type of hardware circuitry. Each core 1602 includes control unit circuitry 1614, arithmetic and logic (AL) circuitry (sometimes referred to as an ALU) 1616, a plurality of registers 1618, the local memory 1620, and a second bus 1622. Other structures may be present. For example, each core 1602 may include vector unit circuitry, single instruction multiple data (SIMD) unit circuitry, load/store unit (LSU) circuitry, branch/jump unit circuitry, floating-point unit (FPU) circuitry, etc. The control unit circuitry 1614 includes semiconductor-based circuits structured to control (e.g., coordinate) data movement within the corresponding core 1602. The AL circuitry 1616 includes semiconductor-based circuits structured to perform one or more mathematic and/or logic operations on the data within the corresponding core 1602. The AL circuitry 1616 of some examples performs integer based operations. In other examples, the AL circuitry 1616 also performs floating-point operations. In yet other examples, the AL circuitry 1616 may include first AL circuitry that performs integer-based operations and second AL circuitry that performs floating-point operations. The AL circuitry 1616 may be referred to as an Arithmetic Logic Unit (ALU).

The registers 1618 are semiconductor-based structures to store data and/or instructions such as results of one or more of the operations performed by the AL circuitry 1616 of the corresponding core 1602. The registers 1618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1618 may be arranged in a bank as shown in FIG. 16. Alternatively, the registers 1618 may be organized in any other arrangement, format, or structure, such as by being distributed throughout the core 1602 to shorten access time. The second bus 1622 may be implemented by at least one of an I2C bus, a SPI bus, a PCI bus, or a PCIe bus.

Each core 1602 and/or, more generally, the microprocessor 1600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1600 is a semiconductor device fabricated to include many transistors interconnected to implement the structures described above in one or more integrated circuits (ICs) contained in one or more packages.

The microprocessor 1600 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those described herein. A GPU, DSP and/or other programmable device can also be an accelerator. Accelerators may be on-board the microprocessor 1600, in the same chip package as the microprocessor 1600 and/or in one or more separate packages from the microprocessor 1600.

FIG. 17 is a block diagram of another example implementation of the programmable circuitry 1512 of FIG. 15. The programmable circuitry 1512 is implemented by FPGA circuitry 1700. The FPGA circuitry 1700 may be implemented by an FPGA. The FPGA circuitry 1700 can be used to perform operations that could otherwise be performed by the microprocessor 1600 of FIG. 16 executing corresponding machine readable instructions. However, once configured, the FPGA circuitry 1700 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1600 of FIG. 16 described above (which is a general purpose device that may be programmed to execute some or all of the machine readable instructions represented by the flowchart(s) of FIGS. 5, 7, 8, 12, and 14 but whose interconnections and logic circuitry are fixed once fabricated), the FPGA circuitry 1700 of FIG. 17 includes interconnections and logic circuitry that may be configured, structured, programmed, and/or interconnected in different ways after fabrication to instantiate some or all of the operations/functions corresponding to the machine readable instructions represented by the flowchart(s) of FIGS. 5, 7, 8, 12, and 14. In particular, the FPGA circuitry 1700 may be thought of as an array of logic gates, interconnections, and switches. The switches can be programmed to change how the logic gates are interconnected by the interconnections, effectively forming one or more dedicated logic circuits (unless and until the FPGA circuitry 1700 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5, 7, 8, 12, and 14. As such, the FPGA circuitry 1700 may be configured and/or structured to effectively instantiate some or all of the operations/functions corresponding to the machine readable instructions of the flowchart(s) of FIGS. 5, 7, 8, 12, and 14 as dedicated logic circuits to perform the operations/functions corresponding to those software instructions in a dedicated manner analogous to an ASIC. Therefore, the FPGA circuitry 1700 may perform the operations/functions corresponding to some or all of the machine readable instructions of FIGS. 5, 7, 8, 12, and 14 faster than the general-purpose microprocessor can execute the same.

In FIG. 17, the FPGA circuitry 1700 is configured and/or structured in response to being programmed (and/or reprogrammed one or more times) based on a binary file. The binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. The FPGA circuitry 1700 of FIG. 17 may access and/or load the binary file to cause the FPGA circuitry 1700 of FIG. 17 to be configured and/or structured to perform the one or more operations/functions. The binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1700 of FIG. 17 to cause configuration and/or structuring of the FPGA circuitry 1700 of FIG. 17, or portion(s) thereof.

The binary file is compiled, generated, transformed, and/or otherwise output from a uniform software platform utilized to program FPGAs. The uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. The FPGA circuitry 1700 of FIG. 17 may access and/or load the binary file to cause the FPGA circuitry 1700 of FIG. 17 to be configured and/or structured to perform the one or more operations/functions. The binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1700 of FIG. 17 to cause configuration and/or structuring of the FPGA circuitry 1700 of FIG. 17, or portion(s) thereof.

The FPGA circuitry 1700 of FIG. 17, includes input/output (I/O) circuitry 1702 to obtain and/or output data to/from configuration circuitry 1704 and/or external hardware 1706. For example, the configuration circuitry 1704 is be implemented by interface circuitry that obtains a binary file, which may be implemented by a bit stream, data, and/or machine-readable instructions, to configure the FPGA circuitry 1700, or portion(s) thereof. In some such examples, the configuration circuitry 1704 obtains the binary file from a user, a machine (e.g., hardware circuitry (e.g., programmable or dedicated circuitry) that implements an Artificial Intelligence/Machine Learning (AI/ML) model to generate the binary file), etc., and/or any combination(s) thereof). The external hardware 1706 may be implemented by external hardware circuitry. The external hardware 1706 may be implemented by the microprocessor 1600 of FIG. 16.

The FPGA circuitry 1700 also includes an array of logic gate circuitry 1708, a plurality of configurable interconnections 1710, and storage circuitry 1712. The logic gate circuitry 1708 and the configurable interconnections 1710 are configurable to instantiate one or more operations/functions that may correspond to at least some of the machine readable instructions of FIGS. 5, 7, 8, 12, and 14 and/or other desired operations. The logic gate circuitry 1708 shown in FIG. 17 is fabricated in blocks or groups. Each block includes semiconductor-based electrical structures that may be configured into logic circuits. The electrical structures include logic gates (e.g., And gates, Or gates, Nor gates, etc.) that provide basic building blocks for logic circuits. Electrically controllable switches (e.g., transistors) are present within each of the logic gate circuitry 1708 to enable configuration of the electrical structures and/or the logic gates to form circuits to perform desired operations/functions. The logic gate circuitry 1708 may include other electrical structures such as look-up tables (LUTs), registers (e.g., flip-flops or latches), multiplexers, etc.

The configurable interconnections 1710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1708 to program desired logic circuits.

The storage circuitry 1712 of the illustrated example is structured to store result(s) of the one or more of the operations performed by corresponding logic gates. The storage circuitry 1712 may be implemented by registers or the like. In the illustrated example, the storage circuitry 1712 is distributed amongst the logic gate circuitry 1708 to facilitate access and increase execution speed.

The FPGA circuitry 1700 of FIG. 17 also includes dedicated operations circuitry 1714. In this example, the dedicated operations circuitry 1714 includes special purpose circuitry 1716 that is invoked to implement commonly used functions to avoid the need to program those functions in the field. Examples of such special purpose circuitry 1716 include memory (e.g., DRAM) controller circuitry, PCIe controller circuitry, clock circuitry, transceiver circuitry, memory, and multiplier-accumulator circuitry. Other types of special purpose circuitry may be present. The FPGA circuitry 1700 may also include general purpose programmable circuitry 1718 such as a CPU 1720 and/or an DSP 1722. Other general purpose programmable circuitry 1718 may be present such as a GPU, an XPU, etc., that can be programmed to perform other operations.

Although FIGS. 16 and 17 illustrate two example implementations of the programmable circuitry 1512 of FIG. 15, many other approaches are contemplated. For example, FPGA circuitry includes an on-board CPU, such as one or more of the CPU 1720 of FIG. 16. Therefore, the programmable circuitry 1512 of FIG. 15 may also be implemented by combining at least the microprocessor 1600 of FIG. 16 and the FPGA circuitry 1700 of FIG. 17. In some such hybrid examples, one or more cores 1602 of FIG. 16 executes a first portion of the machine readable instructions represented by the flowchart(s) of FIGS. 5, 7, 8, 12, and 14 to perform first operation(s)/function(s), the FPGA circuitry 1700 of FIG. 17 is configured and/or structured to perform second operation(s)/function(s) corresponding to a second portion of the machine readable instructions represented by the flowcharts of FIGS. 5, 7, 8, 12, and 14, and/or an ASIC is configured and/or structured to perform third operation(s)/function(s) corresponding to a third portion of the machine readable instructions represented by the flowcharts of FIGS. 5, 7, 8, 12, and 14.

Some or all of the circuitry of FIG. 1 and/or FIGS. 3A, 3B may, thus, be instantiated at the same or different times. Same and/or different portion(s) of the microprocessor 1600 of FIG. 16 may be programmed to execute portion(s) of machine-readable instructions at the same and/or different times. Same and/or different portion(s) of the FPGA circuitry 1700 of FIG. 17 may be configured and/or structured to perform operations/functions corresponding to portion(s) of machine-readable instructions at the same and/or different times.

Some or all of the circuitry of FIG. 1 and/or FIGS. 3A, 3B may be instantiated, for example, in one or more threads executing concurrently and/or in series. The microprocessor 1600 of FIG. 16 may execute machine readable instructions in one or more threads executing concurrently and/or in series. The FPGA circuitry 1700 of FIG. 17 may be configured and/or structured to carry out operations/functions concurrently and/or in series. Moreover, some or all of the circuitry of FIG. 1 and/or FIGS. 3A, 3B may be implemented within one or more virtual machines and/or containers executing on the microprocessor 1600 of FIG. 16.

The programmable circuitry 1512 of FIG. 15 may be in one or more packages. For example, the microprocessor 1600 of FIG. 16 and/or the FPGA circuitry 1700 of FIG. 17 may be in one or more packages. An XPU may be implemented by the programmable circuitry 1512 of FIG. 15, which may be in one or more packages. The XPU may include a CPU (e.g., the microprocessor 1600 of FIG. 16, the CPU 1720 of FIG. 17, etc.) in one package, a DSP (e.g., the DSP 1722 of FIG. 17) in another package, a GPU in yet another package, and an FPGA (e.g., the FPGA circuitry 1700 of FIG. 17) in still yet another package.

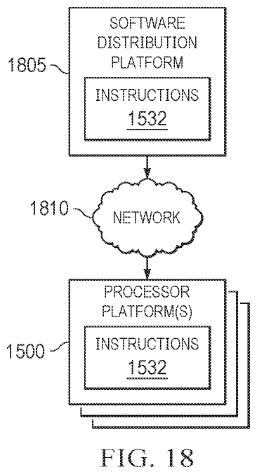

A block diagram illustrating an example software distribution platform 1805 to distribute software such as the machine readable instructions 1532 of FIG. 15 to other hardware devices (e.g., hardware devices owned and/or operated by third parties from the owner and/or operator of the software distribution platform) is illustrated in FIG. 18. The software distribution platform 1805 may be implemented by any computer server, data facility, cloud service, etc., capable of storing and transmitting software to other computing devices. The third parties may be customers of the entity owning and/or operating the software distribution platform 1805. The entity that owns and/or operates the software distribution platform 1805 may be a developer, a seller, and/or a licensor of software such as the machine readable instructions 1532 of FIG. 15. The third parties may be consumers, users, retailers, OEMs, etc., who purchase and/or license the software for use and/or re-sale and/or sub-licensing. In the illustrated example, the software distribution platform 1805 includes one or more servers and one or more storage devices. The storage devices store the machine readable instructions 1532, which may correspond to the machine readable instructions of FIGS. 5, 7, 8, 12, and 14, as described above. The one or more servers of the software distribution platform 1805 are in communication with an example network 1810, which may correspond to any one or more of the Internet and/or any of the networks described above. The one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1532 from the software distribution platform 1805. The software, which may correspond to the machine readable instructions of FIGS. 5, 7, 8, 12, and 14, may be downloaded to the programmable circuitry platform 1500, which is to execute the machine readable instructions 1532 to implement the egress time correction circuitry or the ingress time correction circuitry. One or more servers of the software distribution platform 1805 periodically offer, transmit, and/or force updates to the software (e.g., the machine readable instructions 1532 of FIG. 15) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been described that facilitate improved precise timestamping of network communications. Described systems, apparatus, articles of manufacture, and methods improve the efficiency of using a computing device by determining, predicting, and/or estimating variable delays due to encoding and/or decoding and adjusting timestamps to offset for the variable delays. By eliminating variable delays, a consistent clock adjustment measurement can be determined and utilized to adjust a clock of a slave device to synchronize the clock of the slave device with a clock of a master time server or other device. Described systems, apparatus, articles of manufacture, and methods are accordingly directed to one or more improvements(s) in the operation of a machine such as a computer or other electronic and/or mechanical device.

Example methods, apparatus, systems, and articles of manufacture for precise timestamping for Ethernet frames are disclosed herein. Further examples and combinations thereof include the following:

Example 1 includes an apparatus comprising network interface circuitry, logic circuitry configured to execute instructions to cause the logic circuitry to determine a first delay introduced by a physical coding sublayer circuitry at a first time, adjust a first timestamp associated with a first transmission based on the first delay, the first timestamp transmitted with the first transmission, determine a second delay introduced by the physical coding sublayer circuitry at a second time, the second delay different than the first delay, and adjust a second timestamp associated with a second transmission based on the second delay, the second timestamp transmitted with the second transmission.

Example 2 includes the apparatus of example 1, wherein the instructions cause the logic circuitry to determine the first delay at a start of transmission of a first signal and to determine the second delay at the start of transmission of a second signal.

Example 3 includes the apparatus of example 1, wherein the instructions cause the logic circuitry to insert the first timestamp in a time synchronization message.

Example 4 includes the apparatus of example 1, wherein the instructions cause the logic circuitry to determine the first delay based on a state of the physical coding sublayer circuitry.

Example 5 includes the apparatus of example 4, wherein the state of the physical coding sublayer circuitry includes an alignment between a first clock signal and a second clock signal.

Example 6 includes the apparatus of example 5, wherein the instructions cause the logic circuitry to determine the first delay based on a difference between a first edge of the first clock signal and a second edge of the second clock signal.

Example 7 includes the apparatus of example 6, wherein the instructions cause the logic circuitry to determine the first delay based on a difference between a first rising edge of the first clock signal and a second rising edge of the second clock signal.

Example 8 includes the apparatus of example 1, wherein the physical coding sublayer circuitry includes encoder circuitry and the instructions cause the logic circuitry to determine the first delay of the encoder circuitry.

Example 9 includes the apparatus of example 8, wherein the encoder circuitry is error correction circuitry.

Example 10 includes the apparatus of example 9, wherein the encoder circuitry is Reed-Solomon error correction circuitry.

Example 11 includes the apparatus of example 9, wherein the instructions cause the logic circuitry to determine the first delay based on a relative position of a start of a packet in a frame of the encoder circuitry.

Example 12 includes the apparatus of example 9, wherein the first delay is associated with a first frame of data and the instructions cause the logic circuitry to determine the second delay for a second frame of the data as a number of cycles less than the first delay.

Example 13 includes an apparatus comprising network interface circuitry, clock circuitry, logic circuitry configured to execute instructions to cause the logic circuitry to determine a first delay introduced by a physical coding sublayer circuitry at a first time, adjust a first timestamp associated with a first received time synchronization message, determine a second delay introduced by the physical coding sublayer circuitry at second first time, adjust a second timestamp associated with a second received time synchronization message, the second received time synchronization message associated with the first received time synchronization message, and adjust a time value of the clock circuitry based on a difference between the first timestamp and the second timestamp. 13 the apparatus of example 12, wherein the logic circuitry is to adjust the time value further based on a third timestamp and a fourth timestamp.

Example 14 includes the apparatus of example 13, wherein the instructions cause the logic circuitry to determine the first delay based on a state of the physical coding sublayer circuitry.

Example 15 includes the apparatus of example 13, wherein the instructions cause the logic circuitry to determine the first delay based on a first variable delay of a first bit level conversion.

Example 16 includes the apparatus of example 15, wherein the instructions cause the logic circuitry to determine the first delay further based on a second variable delay of a second bit level conversion.

Example 17 includes the apparatus of example 13, wherein the instructions cause the logic circuitry to determine the first delay based on a variable delay of an error correction process.

Example 18 includes a method comprising adjusting a first timestamp based on a first delay of a first physical coding sublayer associated with receiving a first time synchronization message, adjusting a second timestamp based on a second delay of a second physical coding sublayer associated with transmission of a second time synchronization message, and adjust a clock time based on at least the first timestamp and the second timestamp.

Example 19 includes the method of example 18, further comprising transmitting the second time synchronization message to a time server.

Example 20 includes the method of example 18, further comprising inserting the second timestamp into the second time synchronization message.

It is noted that this patent claims priority from Indian Provisional Patent Application Number 202341020859, which was filed on Mar. 24, 2023, and is hereby incorporated by reference in its entirety.

Descriptors “first,” “second,” “third,” etc. are used herein when identifying multiple elements or components which may be referred to separately. Unless otherwise specified, such descriptors do not impute any meaning of priority, physical order, or arrangement in a list, or ordering in time but are merely used as labels for referring to multiple elements or components separately for ease of understanding the described examples. The descriptor “first” may be used to refer to an element in the detailed description, while the same element may be referred to in a claim with a different descriptor such as “second” or “third.” In such instances, such descriptors are used merely for ease of referencing multiple elements or components.

In the description and in the claims, the terms “including” and “having” and variants thereof are inclusive in a manner similar to the term “comprising” unless otherwise noted. Unless otherwise stated, “about,” “approximately,” or “substantially” preceding a value means+/−10 percent of the stated value. In another example, “about,” “approximately,” or “substantially” preceding a value means+/−5 percent of the stated value. IN another example, “about,” “approximately,” or “substantially” preceding a value means+/−1 percent of the stated value.

The term “couple”, “coupled”, “couples”, and variants thereof, as used herein, may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A. Moreover, the terms “couple”, “coupled”, “couples”, or variants thereof, includes an indirect or direct electrical or mechanical connection.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

Although not all separately labeled in the FIGS., components or elements of systems and circuits illustrated therein have one or more conductors or terminus that allow signals into and/or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically and/or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node refers to a point of connection or interconnection of two or more terminals. An example number of terminals and nodes may be shown. However, depending on a particular circuit or system topology, there may be more or fewer terminals and nodes. However, in some instances, “terminal”, “node”, “interconnect”, “pad”, and “pin” may be used interchangeably.

Modifications are possible in the described embodiments, and other embodiments are possible, within the scope of the claims.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs).

An XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. An integrated circuit may be implemented as one or more of an ASIC, an FPGA, a chip, a microchip, programmable circuitry, a semiconductor substrate coupling multiple circuit elements, a system on chip (SoC), etc.

As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” refers to implementations including any of (1) at least one A, (2) at least one B, or (3) at least one A and at least one B. Similarly, as used herein in the context of describing structures, components, items, objects and/or things, the phrase “at least one of A or B” refers to implementations including any of (1) at least one A, (2) at least one B, or (3) at least one A and at least one B.

As used herein in the context of describing the performance or execution of processes, instructions, actions, activities and/or steps, the phrase “at least one of A and B” refers to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” refers to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is not feasible and/or advantageous.

Modifications are possible in the described embodiments, and other embodiments are possible, within the scope of the claims.

What is claimed is:

1. An apparatus comprising:
network interface circuitry;
logic circuitry configured to execute instructions to cause the logic circuitry to:
determine a first delay introduced by a physical coding sublayer circuitry at a first time;
adjust a first timestamp associated with a first transmission based on the first delay, the first timestamp transmitted with the first transmission;
determine a second delay introduced by the physical coding sublayer circuitry at a second time, the second delay different than the first delay; and
adjust a second timestamp associated with a second transmission based on the second delay, the second timestamp transmitted with the second transmission.

2. The apparatus of claim 1, wherein the instructions cause the logic circuitry to determine the first delay at a start of transmission of a first signal and to determine the second delay at the start of transmission of a second signal.

3. The apparatus of claim 1, wherein the instructions cause the logic circuitry to insert the first timestamp in a time synchronization message.

4. The apparatus of claim 1, wherein the instructions cause the logic circuitry to determine the first delay based on a state of the physical coding sublayer circuitry.

5. The apparatus of claim 4, wherein the state of the physical coding sublayer circuitry includes an alignment between a first clock signal and a second clock signal.

6. The apparatus of claim 5, wherein the instructions cause the logic circuitry to determine the first delay based on a difference between a first edge of the first clock signal and a second edge of the second clock signal.

7. The apparatus of claim 6, wherein the instructions cause the logic circuitry to determine the first delay based on a difference between a first rising edge of the first clock signal and a second rising edge of the second clock signal.

8. The apparatus of claim 1, wherein the physical coding sublayer circuitry includes encoder circuitry and the instructions cause the logic circuitry to determine the first delay of the encoder circuitry.

9. The apparatus of claim 8, wherein the encoder circuitry is error correction circuitry.

10. The apparatus of claim 9, wherein the encoder circuitry is Reed-Solomon error correction circuitry.

11. The apparatus of claim 9, wherein the instructions cause the logic circuitry to determine the first delay based on a relative position of a start of a packet in a frame of the encoder circuitry.

12. The apparatus of claim 9, wherein the first delay is associated with a first frame of data and the instructions cause the logic circuitry to determine the second delay for a second frame of the data as a number of cycles less than the first delay.

13. An apparatus comprising:
network interface circuitry;
clock circuitry;
logic circuitry configured to execute instructions to cause the logic circuitry to:
determine a first delay introduced by a physical coding sublayer circuitry at a first time;
adjust a first timestamp associated with a first received time synchronization message;
determine a second delay introduced by the physical coding sublayer circuitry at second first time;
adjust a second timestamp associated with a second received time synchronization message, the second received time synchronization message associated with the first received time synchronization message; and
adjust a time value of the clock circuitry based on a difference between the first timestamp and the second timestamp.

14. The apparatus of claim 13, wherein the instructions cause the logic circuitry to determine the first delay based on a state of the physical coding sublayer circuitry.

15. The apparatus of claim 13, wherein the instructions cause the logic circuitry to determine the first delay based on a first variable delay of a first bit level conversion.

16. The apparatus of claim 15, wherein the instructions cause the logic circuitry to determine the first delay further based on a second variable delay of a second bit level conversion.

17. The apparatus of claim 13, wherein the instructions cause the logic circuitry to determine the first delay based on a variable delay of an error correction process.

18. A method comprising:
adjusting a first timestamp based on a first delay of a first physical coding sublayer associated with receiving a first time synchronization message;
adjusting a second timestamp based on a second delay of a second physical coding sublayer associated with transmission of a second time synchronization message; and
adjust a clock time based on at least the first timestamp and the second timestamp.

19. The method of claim 18, further comprising transmitting the second time synchronization message to a time server.

20. The method of claim 18, further comprising inserting the second timestamp into the second time synchronization message.
